(19) United States
(12) Patent Application Publication
(10) Pub. No.: US 2014/0313195 A1
(43) Pub. Date: Oct. 23, 2014

(54) 3D Model Mapping

(71) Applicant: Cherif Atia Algreatly, Newark, CA (US)

(72) Inventor: Cherif Atia Algreatly, Newark, CA (US)

(73) Assignee: Cherif Atia Algreatly, Newark, CA (US)

(21) Appl. No.: 14/320,673

(22) Filed: Jul. 1, 2014

Related U.S. Application Data
(63) Continuation-in-part of application No. 12/072,976, filed on Feb. 29, 2008.
Application No. 12/072,976 is a continuation-in-part of application No. 13/507,745, filed on Jul. 24, 2012.

(51) Int. Cl. G06T 17/20

(52) U.S. Cl. CPC G06T 17/20
USPC 345/423

(57) ABSTRACT

A method is disclosed for mapping a 3D model with a 3D matrix. The method places the 3D model in a 3D grid, comprised of 3D units, and tags each 3D unit with an identifier to be indicated in the cells of the 3D matrix. Analyzing the identifiers in the 3D matrix allows the computer system to automatically recognize the identity of the 3D model, extract positional or numerical information regarding the 3D model, find a path connecting two spots in the 3D model, and detect an error in the 3D model according to any particular criteria.

### CROSS-REFERENCE TO RELATED APPLICATION

This application is a Continuation-in-Part of co-pending U.S. patent application Ser. No. 12/072,976, filed Feb. 29, 2008, titled “Graphical Data Mapping technique”, and Ser. No. 13/507,745, filed Jul. 24, 2012, titled “3-D Representation Method and System”.

### BACKGROUND

The medical, engineering, industrial, and IT fields are examples of fields that utilize a computer display to present virtual 3D models for the purpose of analysis, design, or interaction. In essence, when a computer displays a 3D model, it perceives it mainly as raw data, in the form of a point cloud, lines of a wireframe, plurality of curves, collections of polygons, and the like. This contrasts with how humans perceive graphical data: they see it as information, or data in its usable form that is initially processed by analysis of the constituent parts of a whole, then synthesized as a whole, and finally interpreted. However, until recently there have not been any methods or techniques that enable a computer to perceive 3D models in the same manner of perception as a human. A computer lacks the capacity to help a human by being unable to automate many simple and complex tasks that depend mainly on interpreting the visual data inherent in virtual 3D models.

Should such a method of interpretation come into being, a computer would be capable of helping humans complete complex professional tasks in various fields such as medical, engineering, industrial, and IT fields. For example, in the medical field, creating a 3D medical model of a patient's ailing organ on the computer display will allow a computer equipped with a “human” method of interpretation to diagnose the medical problem afflicting this organ. In the engineering field, it would be possible to display a video of a 3D model representing a collapse or explosion of a building and enable the computer to analyze and identify the specific cause of this collapse or explosion. These and other examples can be performed in a manner similar to a human's method of perception once the computer is able to extract useful information from the digital data of the 3D models.

### SUMMARY

In one embodiment, the present invention discloses a method to immerse a 3D model in a 3D grid and map the 3D model with a 3D matrix representing the immersion of the 3D model in the 3D grid. This method is comprised of four steps. The first step is to immerse the 3D model in a 3D grid comprised of 3D units. The second step is to identify each inner 3D unit of the 3D units that are located inside the 3D model. The third step is to tag each inner 3D unit with an identifier representing its surrounding 3D units. The fourth step is to form a 3D matrix comprised of layers of 2D matrices, where each cell of the 2D matrices represents a 3D unit and contains the identifier of the 3D unit. In one embodiment, the 3D model is created using a 3D grid and, in this case, this 3D grid is used to immerse the 3D model. In another embodiment, the 3D model is a three-dimensional wireframe model represented by sets of lines abiding to a vector graphics format, where each set of lines represents a surface. In this case, when using a 3D grid, the inner 3D units of the 3D grid are the 3D units that are completely located inside the three-dimensional wireframe model.

In one embodiment of the present invention, the 3D units of the 3D grid are identical, meaning they have the same shape and dimensions. In another embodiment of the present invention, the 3D units are not identical, which means they do not have the same shape or dimensions. In one embodiment, each one of the 2D matrices of the 3D matrix is comprised of two sets of data that can be represented by a rectangular array. In another embodiment, each one of the 2D matrices is comprised of two sets of data that can be represented by a circular array. There are other arrays as well which are not rectangular or circular and hold another form entirely. In another embodiment, each one of the 2D matrices is comprised of more than two sets of data. In the cases of certain 3D models, two or more 3D grids are simultaneously used to immerse the 3D model. In this case, each one of the 2D matrices is comprised of two or more matrices representing the two or more 3D grids.

Analyzing the identifiers located in the 2D matrices using an analysis program allows the computer system to extract useful information from the digital data provided by the 3D model. In one embodiment of the present invention, analyzing the identifiers of the cells of the 2D matrices allows the computer system to recognize the identity of the 3D model. In another embodiment, analyzing the identifiers allows the computer system to extract positional information related to the parts of the 3D model relative to each other. This is achieved by comparing the positions of the cells of 2D matrices relative to each other or relative to a base point or spot. In one embodiment, analyzing the identifiers of the 2D matrices allows the computer system to extract numerical information, such as length, area or volume, related to the 3D model. This is achieved by computing the number of specific cells of the 2D matrices that represent this length, area, or volume. In yet another embodiment, analyzing the identifiers of the 2D matrices allows the computer system to find a path between two separate parts of the 3D models. This is done by determining which group of cells in the 2D matrices are attached to each other and follows this creating a path. In one embodiment, analyzing the identifiers of the 2D matrices enables the computer system to detect an error in the 3D model. This is achieved by comparing the identifiers of the cells of the 2D matrices to a particular criteria related to this error.

The above Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example of a 2D grid comprised of squares attached to each other along the x and y-axis.

FIGS. 2 and 3 illustrate creating a 2D shape on the 2D grid by selecting a plurality of squares in the 2D grid.

FIG. 4 illustrates another example of a 2D grid comprised of squares which are partially attached to each other.

FIGS. 5 and 6 illustrate selecting a plurality of grid squares to create a 2D shape on the 2D grid.

FIG. 7 illustrates another example of a 2D grid comprised of a plurality of hexagons attached to each other.

FIGS. 8 and 9 illustrate selecting a plurality of hexagons to create a 2D shape on the 2D grid.

FIG. 10 illustrates an example of a 2D grid in the form of circles divided into sectors.

FIG. 11 illustrates creating a 2D shape on the 2D grid by selecting some of its sectors.

FIG. 12 illustrates an example of a 3D grid comprised of cubes attached to each other along the x, y, and z-axis.

FIG. 13 illustrates creating a 3D object by selecting a plurality of the cubes on the 3D grid.

FIG. 14 illustrates a 3D grid in the form of a sphere divided into sectors or 3D units.

FIG. 15 illustrates creating a 3D object by selecting some of the 3D units of the 3D grid.

FIGS. 16 and 17 illustrate dividing an existing 3D object into a plurality of 3D units in the form of cubes.

FIG. 18 illustrates five cubes attached to each other, creating a 3D object.

FIGS. 19 and 20 illustrate a 3D matrix representing the 3D object.

FIG. 21 illustrates a 3D matrix representing a 3D grid in the form of a cylinder divided horizontally into two layers and vertically into eight sectors.

FIG. 22 illustrates a 3D grid in the form of a cylinder divided horizontally into two layers and vertically into eight sectors.

FIG. 23 illustrates a 3D matrix representing a 3D grid in the form of a sphere divided horizontally and vertically into layers and sectors.

FIG. 24 illustrates a 3D matrix representing a hollow sphere, where analyzing the identifiers of the 3D matrix allows the computer system to recognize the identity of the hollow sphere.

FIG. 25 illustrates a 3D matrix representing a solid cone, where analyzing the identifiers of the 3D matrix allows the computer system to recognize the identity of the solid cone.

FIG. 26 illustrates an example of a 3D model that can be converted into a 3D matrix to represent the characteristic of this 3D model.

### DETAILED DESCRIPTION

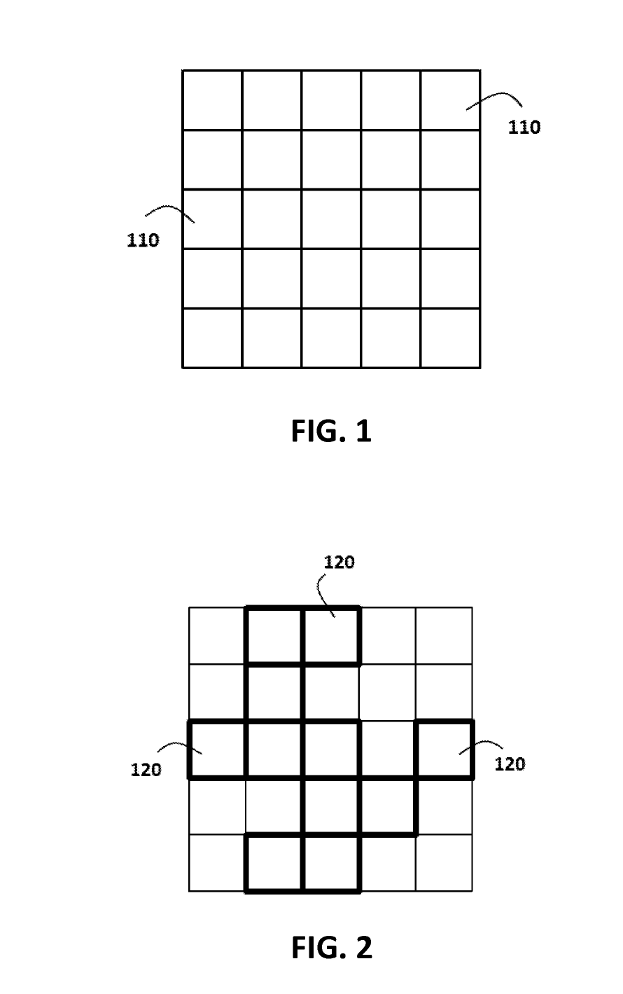

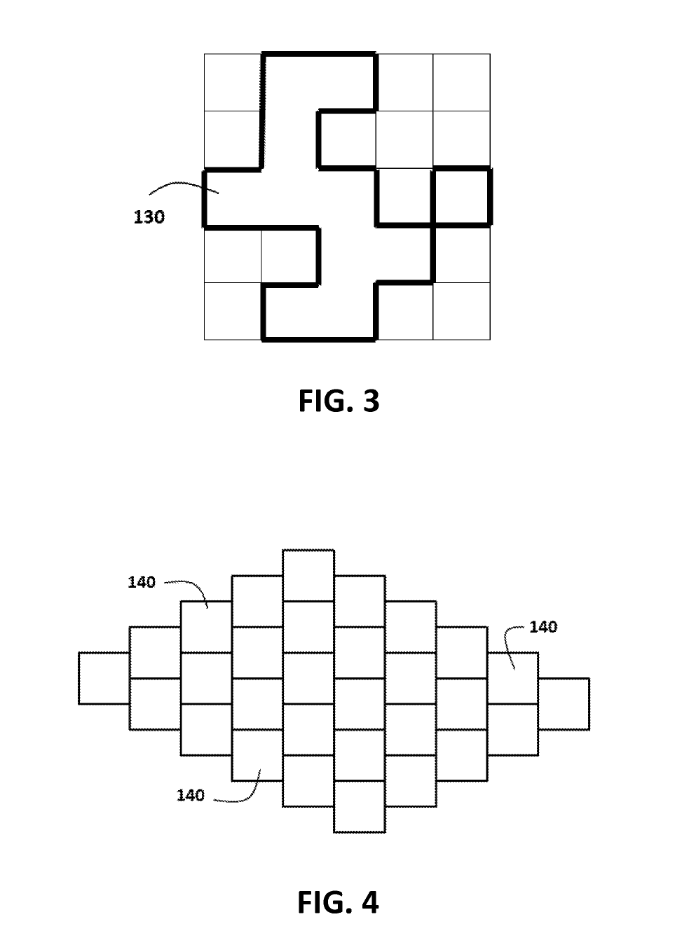

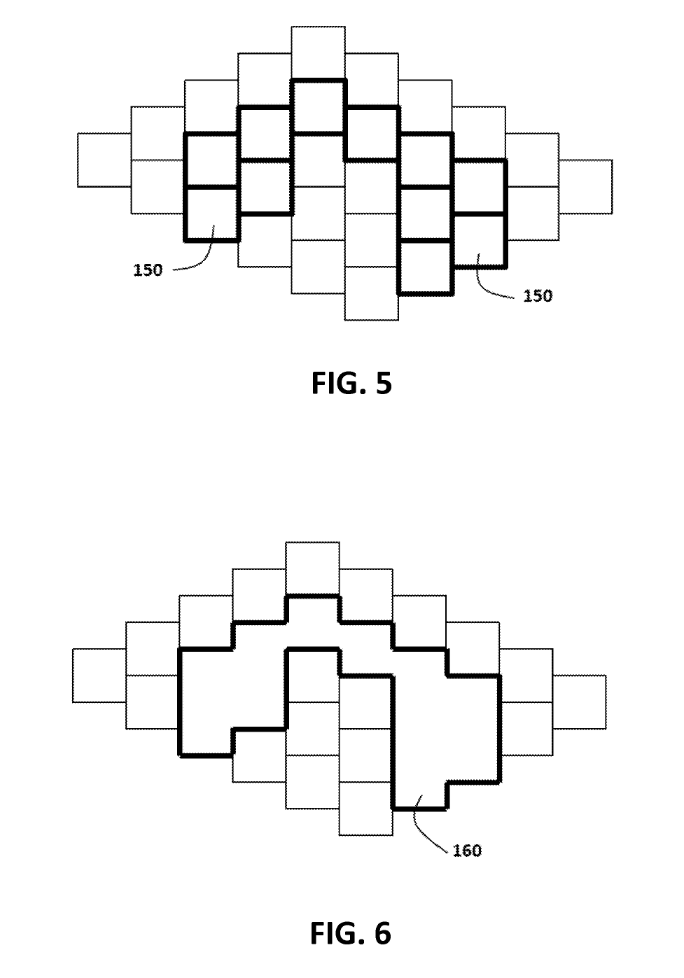

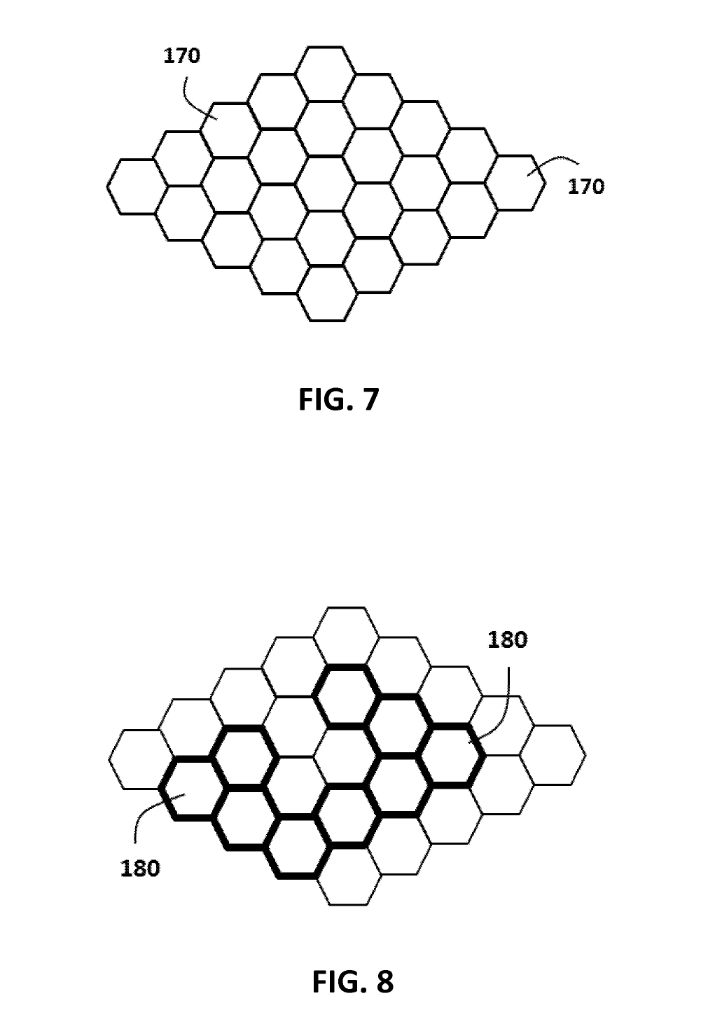

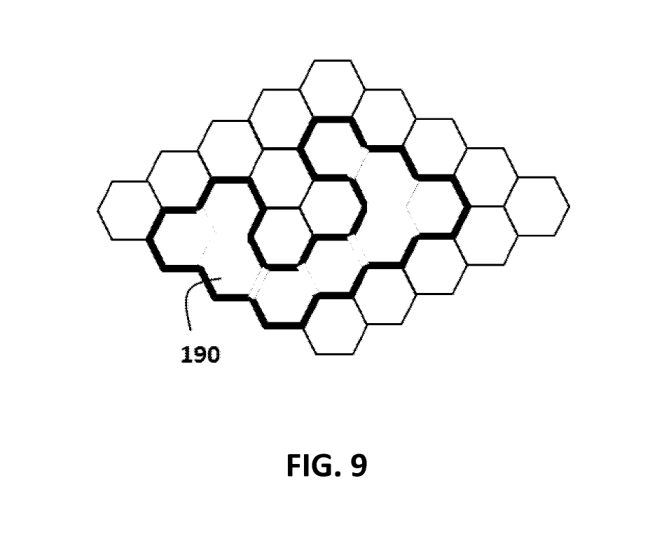

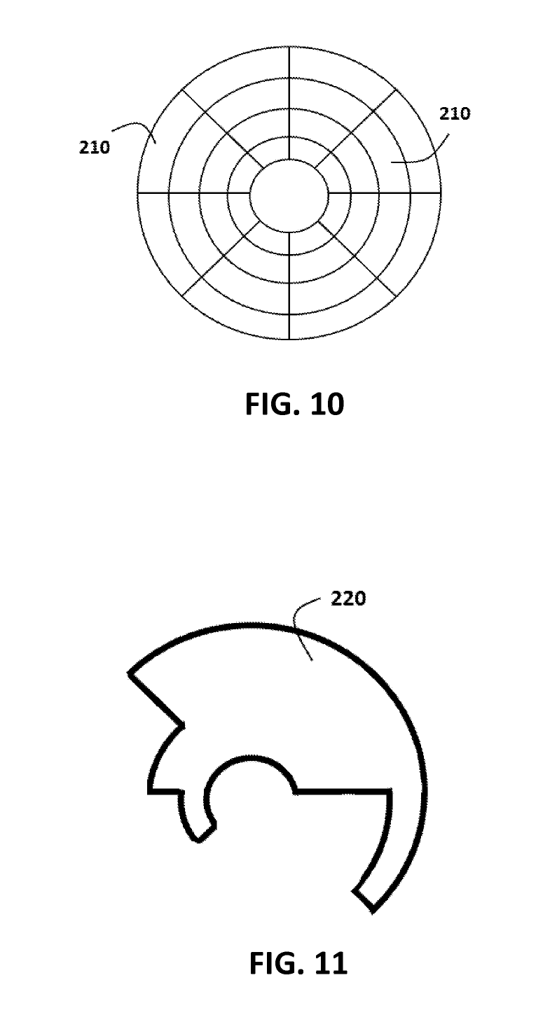

FIG. 1 illustrates a 2D grid comprised of squares 110 attached to each other along the x and y-axis. FIG. 2 illustrates selecting a plurality of grid squares 120 to create the 2D shape 130 illustrated in FIG. 3. FIG. 4 illustrates the same number of the squares 140 of the 2D grid of FIG. 1 after attaching them to each other in formation other than the form of FIG. 1. FIG. 5 illustrates selecting a plurality of these squares 250 to create the 2D shape 260 illustrated in FIG. 6. As shown in the previous figures, the 2D grids can be comprised of a plurality of identical 2D units positioned at equal distance and angles relative to each other. The 2D units can be squares, rectangles, triangles, hexagons, octagons, or any other symmetrical polygons. FIG. 7 illustrates another 2D grid comprised of a plurality of hexagons 170 attached to each other. FIG. 8 illustrates selecting a plurality of the hexagons 180 to create the 2D shape 190 illustrated in FIG. 9. FIG. 10 illustrates another 2D grid comprised of units that have different areas or dimensions. As shown in the figure, the 2D grid is derived from circles divided into sectors 210. FIG. 11 illustrates creating a 2D shape 220 on this 2D grid by selecting specific sectors.

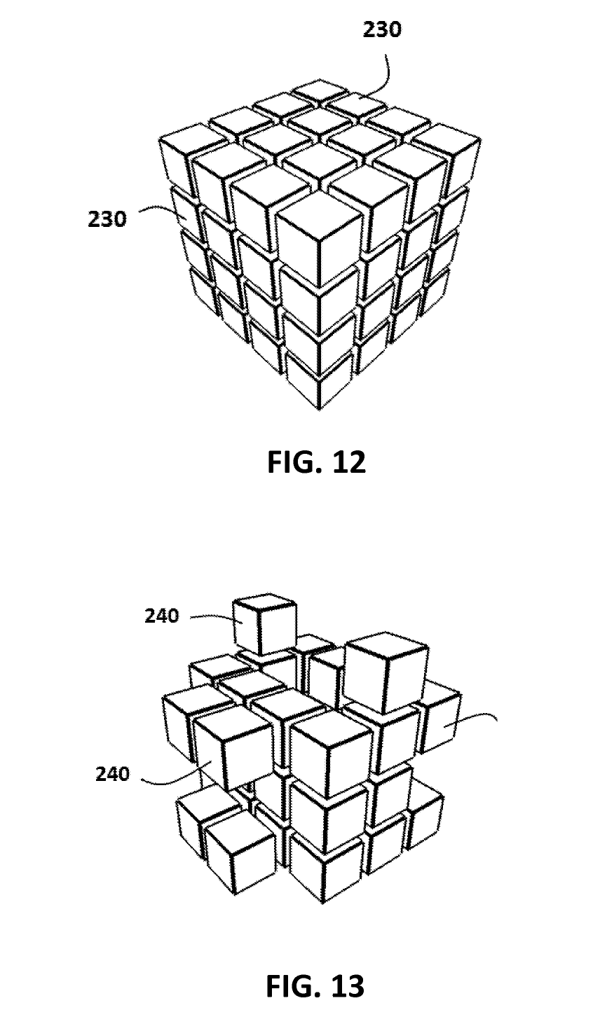

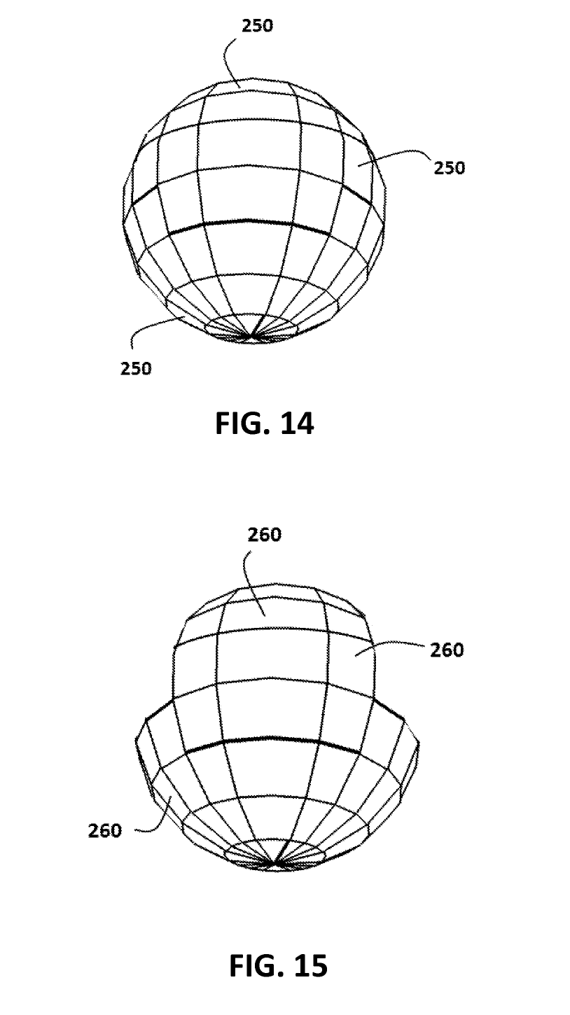

The previous figures illustrate examples of 2D grids that a user can utilize to create 2D shapes by selecting some 2D units locating on the 2D grids. In a similar manner, it is possible to use 3D grids comprised of 3D units to create 3D objects. For example, FIG. 12 illustrates an example of a 3D grid comprised of cubes 230 attached to each other along the x, y, and z-axis. FIG. 13 illustrates creating a 3D object by selecting a plurality of these cubes 240. As shown in this example, the 3D units of the 3D grid are identical. FIG. 14 illustrates another 3D grid in the form of a sphere divided into sectors or 3D units 250. FIG. 15 illustrates creating a 3D object by selecting some of the 3D units 260 of the sphere. As shown in this example, the 3D units of the 3D grid are not identical.

Generally, the present invention discloses a method that allows a computer system to extract information about the 3D model in an automated manner. The method is comprised of four steps. The first step is to immerse the 3D model in a 3D grid comprised of 3D units. The second step is to identify each inner 3D unit of the 3D units located within the 3D model. The third step is to tag each inner 3D unit with an identifier representing the surrounding 3D units. The fourth step is to form a 3D matrix comprised of layers of 2D matrices, wherein each cell of the 2D matrices represent a 3D unit and contains the identifier of the 3D unit.

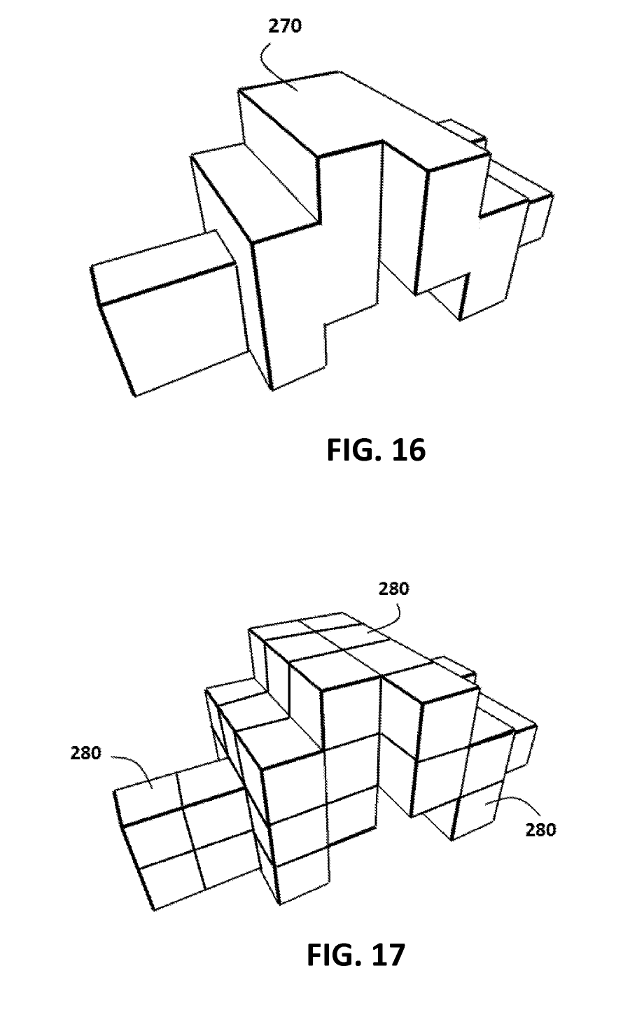

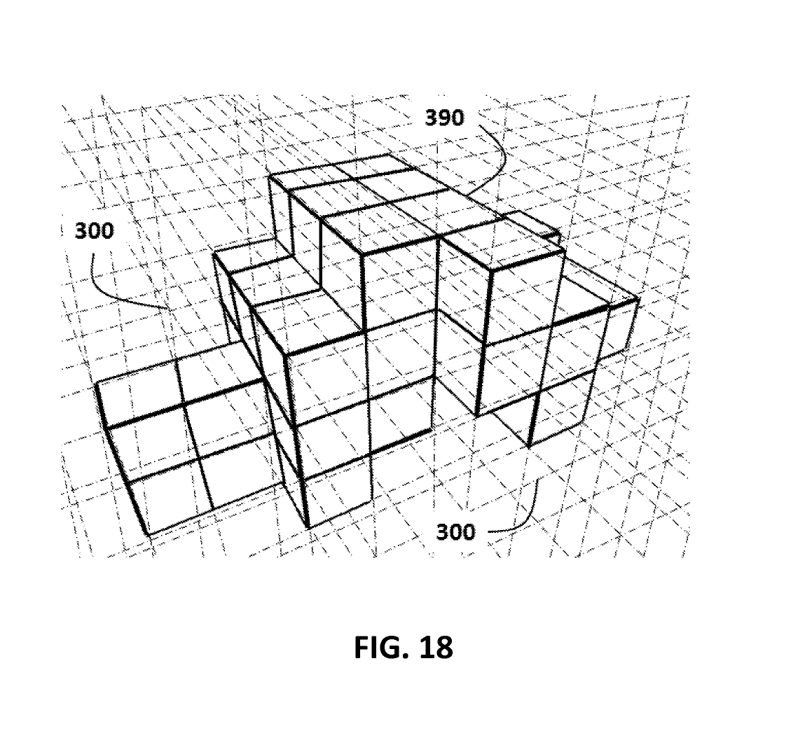

In one embodiment, if the 3D model was already created using a 3D grid, this specific 3D grid is used to immerse and divide the 3D model into 3D units. For example, FIG. 16 illustrates a 3D model 270 created by using a 3D grid comprised of 3D units in the form of cubes. FIG. 17 illustrates immersing the 3D model in this 3D grid to divide the 3D model into 3D units or cubes 280. In another embodiment, if the 3D model is in the form of a three-dimensional wireframe model, represented by sets of lines according to a vector graphics format, then a 3D grid is used to immerse and divide the 3D model into 3D units. For example, FIG. 18 illustrates the same 3D model 290 in the form of a three-dimensional wireframe, where a 3D grid 300 is used to completely immerse the 3D model. The 3D grid is comprised of 3D units in the form of cubes. The 3D units that are completely located inside the 3D model are called “inner units”, where these inner units divide the 3D model into cubes.

After immersing the 3D model in a 3D grid, the inner units of the 3D grid are determined. As mentioned previously, if the 3D model was created using a 3D grid, and the 3D model is defined with the units of this 3D grid, then the inner units are already defined. If the 3D model is in the form of a three-dimensional wireframe and a 3D grid is used to immerse this 3D model, then each 3D unit of the 3D grid will be checked if it is located or not within the 3D model. To achieve this, each face of a 3D unit has its location checked to make sure it is located or not within the 3D model. If all faces of the same 3D unit are located inside the 3D model, then the 3D unit is considered an inner unit. If one or more faces of a 3D unit are partially or entirely located outside the 3D model, then this 3D unit is not considered an inner unit.

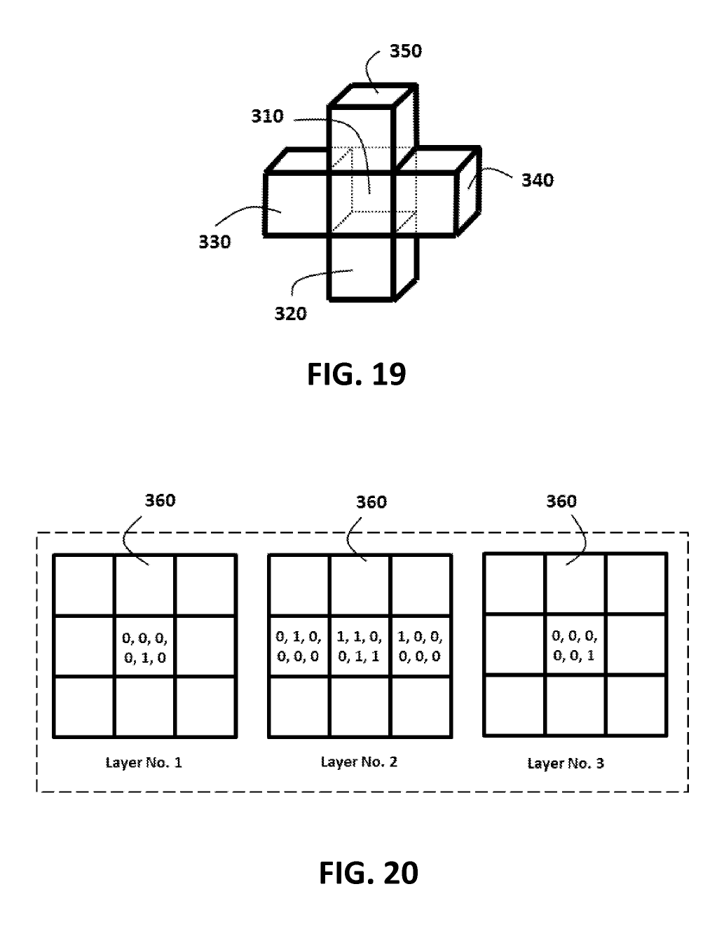

Once the inner units are determined, each one of them is tagged with an identifier representing its surrounding 3D units. For example, if the inner units are cubes, where each cube is surrounded by six other cubes, then the identifier of each inner unit is comprised of six digits representing the six faces of the cube. Each digit of the six digits is either “1” to indicate a face of the cube that is attached to another inner unit, or “0” to indicate a face of the cube that is not attached to another inner unit. For example, FIG. 19 illustrates an inner unit 310 in the form of a cube surrounded by another four inner units or cubes 320-350 from the left, right, top, and bottom sides. The front and back sides of the cube 310 are not attached to any inner units or cubes. Accordingly, the identifier of this inner unit will be “1, 1, 0, 0, 1, 1”, where the first, second, third, fourth, fifth, and six digits of the identifier respectively represent the left, right, front, back, top, and bottom sides of the cube.

FIG. 20 illustrates an example of a 3D matrix representing the 3D model of FIG. 19. As shown in the figure, the 3D matrix is comprised of three layers of 2D matrices 360. The first layer includes a single inner unit with an identifier “0, 0, 0, 0, 1, 0” which indicates a top face of a cube connected to another cube, while the other faces remain unconnected to any cube. The second layer of the 2D matrix contains three inner units, with three respective identifiers “0, 1, 0, 0, 0, 0”, “1, 1, 0, 0, 1, 1”, and “1, 0, 0, 0, 0, 0”. The third layer of the 2D matrix contains a single inner unit with an identifier “0, 0, 0, 0, 0, 1”. In this figure, the identifier of each cell of the 2D matrices was written on two lines to fit the text inside the cell.

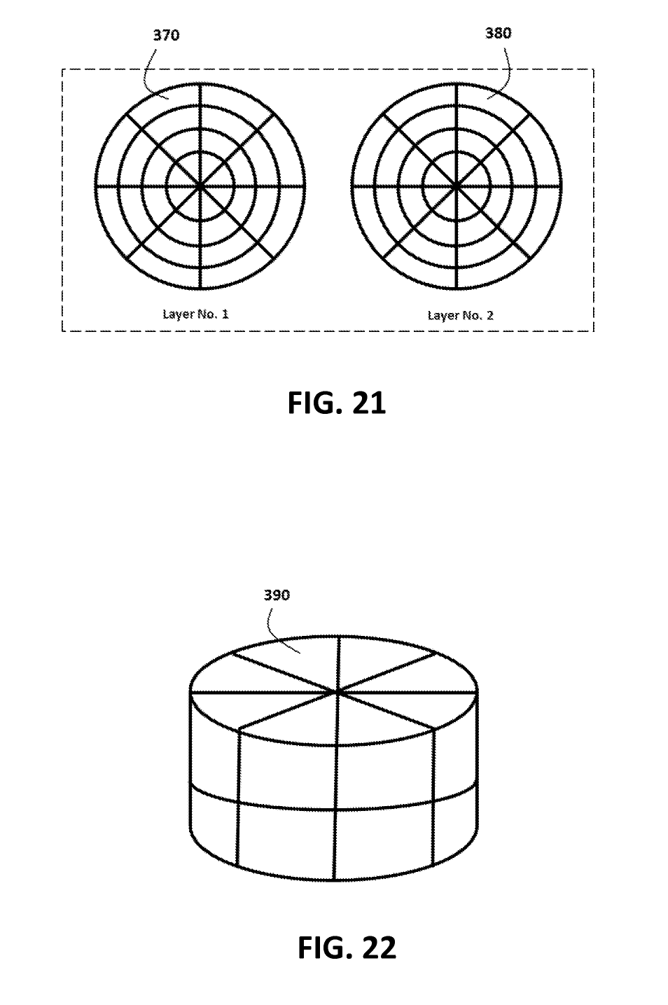

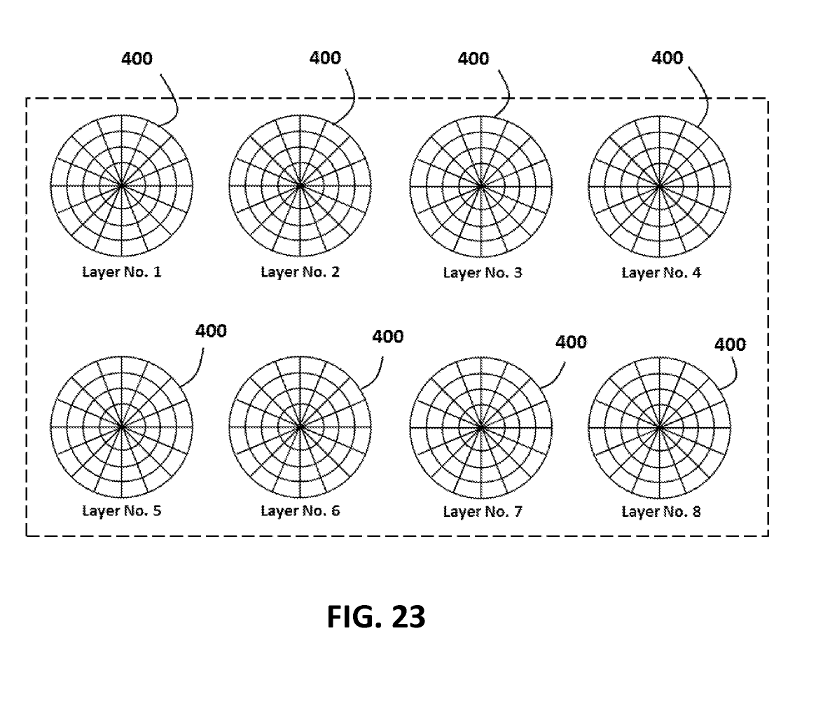

FIG. 21 illustrates another example of a 3D matrix comprised of a first layer 370 and second layer 380 of 2D matrices. The 3D matrix represents the 3D grid 390 illustrated in FIG. 22. As shown in FIG. 21, some cells of the matrices are surrounded by four cells, while other cells are sounded by only three cells. In this case, the identifier of the cell may contain four or three digits, according to the number of surrounding cells. FIG. 23 illustrates a 3D matrix representing the 3D grid of FIG. 14. This 3D matrix is comprised of eight layers of 2D matrices 400, each of which represents a horizontal layer of 3D units comprising the 3D grid of the sphere. Although the sizes of the 3D units differ in each layer of the 3D grid, the cells of the 2D matrices are equally sized. In other words, the sizes of the cells do not represent the real sizes of the 3D units. It is important to note that each 2D matrix of FIG. 21 forms a circular array, compared to the rectangular arrays of FIG. 20. The main difference between the circular array and the rectangular array is that the start of the circular array is connected to its end, a noted consideration when tagging the cells or the inner units with their identifiers.

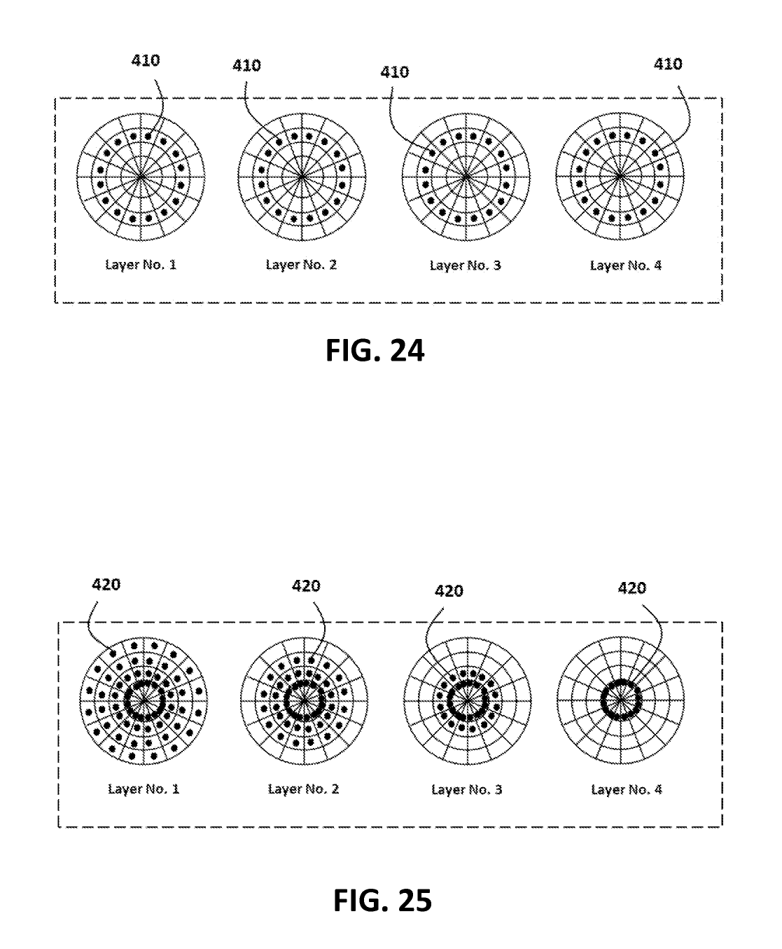

As previously mentioned, analyzing the 3D matrix that represent a 3D model allows the computer system to extract information regarding the 3D model. In one embodiment, the analysis of the 3D matrix automatically identifies the shape or form of the 3D model. For example, to identify a 3D model of a hollow sphere represented by a 3D gird, such as the 3D grid illustrated in FIG. 24, where the black dot 410 in the figure represents a filled cell along with an identifier representing an inner unit. In such a case, the computer system searches for “successive 2D matrices with identical filled cells attached to each other in the form of a hollow circle”. The hollow circle can be identified as a group of cells attached to each other with identical identifiers and symmetrical distance from the center of the 2D matrix. To identify a 3D model of a solid cone represented by a 3D grid, such as the 3D grid illustrated in FIG. 25, where the black dot 420 in the figure represents a filled cell along with an identifier representing an inner unit. In this case, the computer system searches for “successive 2D matrices with filled cells attached to each other in the form of a filled circle with ascending or descending area order”. The filled circle can be identified as a group of hollow circles attached to each other”. In a similar manner other 3D shapes such as cubes, cuboids, cylinders, prisms, and pyramids can be autocratically identified.

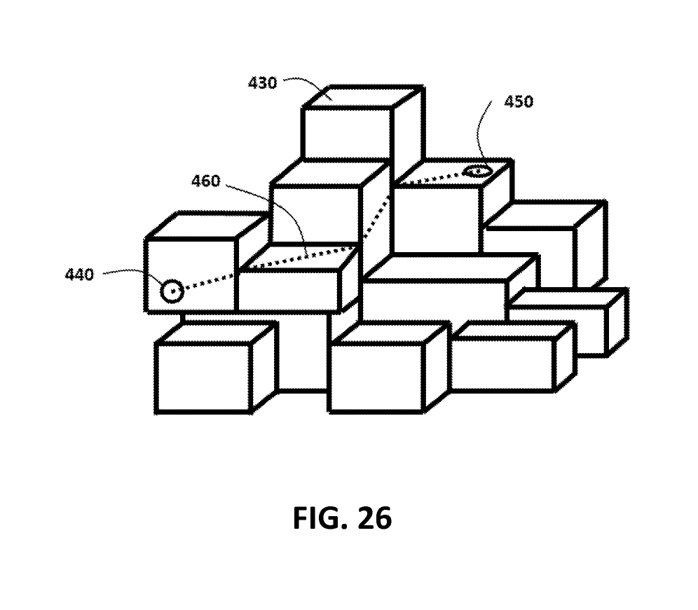

In another embodiment, analyzing the identifiers of a 3D matrix representing a 3D model allows the computer system to extract positional information. For example, FIG. 26 illustrates an example of a 3D model 430 that can be converted into a 3D matrix to represent the characteristic of this 3D model. To determine the relative position between the two spot 440 and 450 located on the 3D model, the relative position of the cells representing the two spots are compared relative to each other. The position of each one of the two cells is determined by using the x, y, and z coordinates of each cell, where subtracting the values of these coordinates determines the distance between the two spots along the x, y, and z-axis. If each spot is represented by multiple cells, the centroid of each multiple cells is used to represent the position of each spot.

In another embodiment, analyzing the identifiers of a 3D matrix representing a 3D model allows the computer system to extract numerical information, such as an area or volume relative to the 3D model. For example, to determine the area of the 3D model that has a direct view to the top, each cell of a 2D matrix is compared to other cells located right on top of it in the upper layers of the 2D matrixes. If a cell has an identifier and other cells located above it have no identifiers, then this cell is considered to be a direct view of the top direction. The total number of such cells represents all cells that have a direct view of the top direction. Calculating the areas of these cells determines the area of the 3D model that have a direct view of the top direction. Another example, to calculate the volume of the 3D model or a part of the 3D model, the number of the inner units located inside the 3D model or the part of the 3D model are used to represent the required volume. The number of the inner units can be represented by the number of cells that include identifiers. Multiplying this number by the volume of the 3D unit determines the required volume.

In one embodiment, analyzing the identifiers of a 3D matrix representing a 3D model allows the computer system to find a path between two separate parts of the 3D model. For example, to find a path located on the exterior surface of the 3D model to connect the two spots 440 and 450, such as the path 460 which is indicated by the dashed lines. In this case, the inner units that intersect with a line connecting the two spots are determined. Each one of these inner units will contain a part of the line, this part is projected on one side of each inner unit that has an exterior exposure. The exterior exposure of the inner unit can be determined by the analysis of the cell identifier that represents the inner unit. For example, an identifier that includes the digit “0” of a 3D unit side means this 3D unit has an exterior exposure from this side. Connecting the projected lines on each exterior side of exterior 3D unit leads to automatically generating the path 460, which is illustrated in the figure.

In another embodiment, analyzing the identifiers of a 3D matrix representing a 3D model allows the computer system to detect an error in the 3D model. This is achieved by comparing the identifiers of the cells of the 2D matrices to a particular criteria related to this error. In one embodiment, the particular criteria includes a form of a group of identifiers that represent an identity of a 3D model or a part of the 3D model. In another embodiment, the particular criteria includes positional data related to the parts of the 3D model relative to each other. In one embodiment, the particular criteria includes numerical information such as lengths, areas, or volume related to the 3D model or its parts. In yet another embodiment, the particular criteria includes a description of one or more paths connecting two points, spots, or objects on the 3D model.

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A method for representing a 3D model wherein the method comprising;
immersing the 3D model in a 3D grid comprised of 3D units;
identifying each inner 3D unit of the 3D units that are located inside the 3D model;
tagging the each inner 3D unit with an identifier representing the surrounding 3D units; and
forming a 3D matrix comprised of layers of 2D matrices wherein each cell of the 2D matrices represents an inner unit of the 3D units and contains the identifier of the inner unit.
The method of claim 1 wherein the 3D model is created using the 3D grid.
The method of claim 1 wherein the 3D model is in the form of three-dimensional wireframe model represented by sets of lines according to a vector graphics format wherein each set of lines represents a surface.
The method of claim 1 wherein the 3D units are identical which means the 3D units have the same shape and dimensions.
The method of claim 1 wherein the 3D units are not identical which means the 3D units do not have the same shape or dimensions.
The method of claim 1 wherein each one of the 2D matrices is comprised of two sets of data that can be represented by a rectangular array.
The method of claim 1 wherein each one of the 2D matrices is comprised of two sets of data that can be represented by a circular array.
The method of claim 1 wherein each one of the 2D matrices is comprised of more than two sets of data.
The method of claim 1 wherein the 3D grid is two or more 3D grids that simultaneously immerse the 3D model.
The method of claim 1 wherein analyzing the identifiers allows the computer system to recognize the identity of the 3D model.
The method of claim 1 wherein the 3D model is comprised of a plurality of partial 3D models connecting to each other in a certain form wherein analyzing the identifiers allows the computer system to recognize the certain form and the identity of the 3D model
The method of claim 1 wherein analyzing the identifiers allows the computer system to automatically obtain positional information related to the 3D model or the parts of the 3D model.
The method of claim 1 wherein analyzing the identifiers allows the computer system to automatically obtain numerical information related to the 3D model such as length, area or volume.
The method of claim 1 wherein analyzing the identifiers allows the computer system to find a path between two points, spots, or parts of the 3D model.
The method of claim 1 wherein analyzing the identifiers allows the computer system to detect an error in the 3D model according to a particular criteria describing the error.
The method of claim 15 wherein the particular criteria includes a form of the identifiers that represents the identity of the 3D model or the identity of a part of the 3D model.
The method of claim 15 wherein the particular criteria includes positional information related to the 3D model of the parts of the 3D model.
The method of claim 15 wherein the particular criteria includes numerical information such as distances, areas, or volumes related to the 3D model or parts of the 3D model.
The method of claim 15 wherein the particular criteria includes a description of one or more paths connecting two points, spots, or objects belonging to the 3D model.
A representation method of a 3D model comprising;
representing the 3D model with a plurality of 3D units;
tagging each unit of the plurality of 3D units with an identifier representing the surrounding 3D units of the each unit; and
forming a 3D matrix comprised of layers of 2D matrices wherein each cell of the 2D matrices represents one unit of the plurality of 3D units and contains the identifier of the one unit.
